(19) United States
(12) Patent Application Publication
(10) Pub. No.: US 2008/0266625 A1
(43) Pub. Date: Oct. 30, 2008

(54) System for Reading Data on a Holographic Storage Medium

(75) Inventors: Martinus Bernardus Van Der Mark, Best (NL); Jan Frederik Suijver, Eersel (NL); Frank Jeroen Pieter Schuurmans, Valkenswaard (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/158,711

(22) PCT Filed: Dec. 25, 2006
(86) PCT No.: PCT/IB06/55031

§ 371 Date: Jun. 23, 2008

(30) Foreign Application Priority Data
Dec. 27, 2005 (CN) 200510134051.4

(51) Int. Cl. G03H 1/22; H01S 3/083

(52) U.S. Cl. 359/32; 372/94

(57) ABSTRACT

The invention relates to a system for reading data from a holographic storage medium (HSM), said system comprising an optical ring cavity defining a closed optical path so as to recycle the light of a reference beam that is used to read out the holographic storage medium, in view of increasing the light path efficiency by lengthening its path.

### FIELD OF THE INVENTION

The invention relates to a system for reading data on a holographic storage medium.

### BACKGROUND OF THE INVENTION

One of the candidates for a next generation of optical storage is holographic storage medium. In contrast to the known optical disc standards (e.g. CD, DVD, Blu-Ray Disc . . . ) proposing to store data on a layer, holographic storage is based on volumetric storage. This allows for a much higher storage capacity, with typical values of ˜1 TBytes on a 12 cm disc.

However, holographic storage suffers from a relative low light path efficiency during read out of the holographic storage medium. Indeed, the typical light path efficiency from emitted laser photon to detected electron is often in the order of 10⁻⁴ to 10⁻⁵, mainly because of the low diffraction efficiency of the holographic material. This results in a very power inefficient system, hampering the introduction of the holographic storage technology in portable devices.

FIG. 1 illustrates a system for reading out a holographic storage medium HSM. It is recalled that the diffraction efficiency corresponds to the fraction of photons that get diffracted by the hologram that is read out. Due to the small difference in refractive index between the holograms stored in the holographic storage medium and the host material of the holographic storage medium HSM, this number is typically quite low. In such a system, the diffraction efficiency is not good since most of the light from the incoming probe S_in (i.e. readout laser beam) is transmitted (along wave vector k) whereas only the diffracted portion carried out by the diffracted signal S_diff (along wave vector k_{d}) contains information about the data stored in the holographic storage medium. For example, the diffracted signal S_diff may comprise 0.001% of the photons, and the transmitted signal S_trans may comprise 99.999% of the photons.

Furthermore, such a low diffraction efficiency requires the heavy use of error-correction algorithms and noise-suppression techniques to maintain a viable signal-to-noise ratio.

### OBJECT AND SUMMARY OF THE INVENTION

It is an object of the invention to propose an improved system for reading data from a holographic storage medium.

To this end, a system is proposed for reading out a holographic storage medium, said system comprising an optical ring cavity defining a closed optical path.

According to the invention, the light of the reference beam that is used to read out the holographic storage medium is recycled in the ring cavity, allows to increase the light path efficiency.

Detailed explanations and other aspects of the invention will be given below.

### BRIEF DESCRIPTION OF THE DRAWINGS

The particular aspects of the invention will now be explained with reference to the embodiments described hereinafter and considered in connection with the accompanying drawings, in which identical parts or sub-steps are designated in the same way:

FIG. 1 illustrates the readout of a holographic storage medium,

FIG. 2 depicts a linear cavity for reading a holographic storage medium,

FIG. 3 depicts a first embodiment according to the invention for reading a holographic storage medium,

FIG. 4 depicts a second embodiment according to the invention for reading a holographic storage medium,

FIG. 5 depicts a third embodiment according to the invention for reading a holographic storage medium.

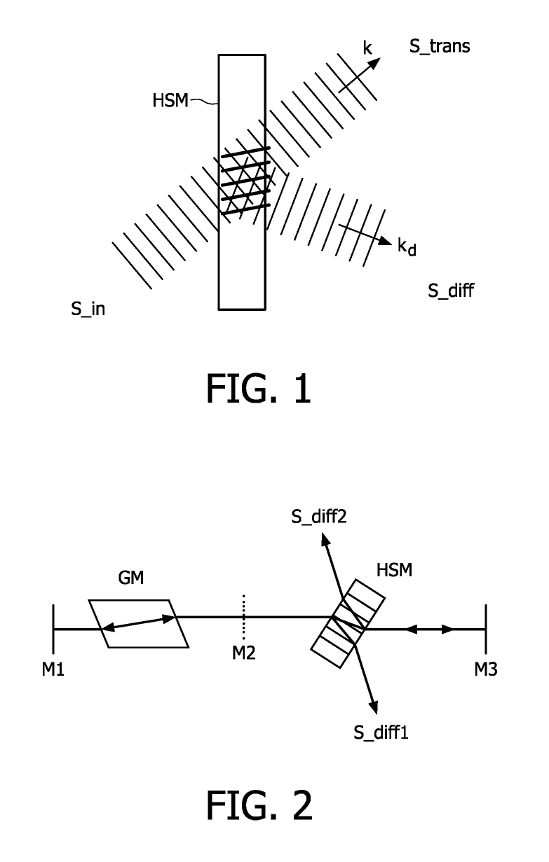

### DETAILED DESCRIPTION OF THE INVENTION

FIG. 2 represents a linear cavity for reading a holographic storage medium. The linear cavity is closed by a first mirror M1 and a second mirror M3. The linear cavity also comprises a gain medium GM and a coupling mirror M2. The readout beam passes through the holographic storage medium HSM twice at each round trip. In the linear cavity, on the return path, the light passes the holographic storage medium HSM in opposite direction. The so-called wave vector k of the light has now become −k, and hence diffraction occurs also in the opposite direction, away from the detector. A first diffracted beam S_diff1 and a second diffracted beam S_diff2 containing information about the data stored in the hologram are thus generated.

Two distinct limiting situations may occur:
The coupling mirror M2 has a very low reflection and is essentially absent. In this case the holographic storage medium HSM is part of the laser cavity (intra cavity configuration) and lasing of the system depends strongly on the hologram properties.

The coupling mirror M2 has a sufficiently high reflection so that lasing occurs even if the holographic storage medium HSM and the mirror M3 are absent. In this extended cavity configuration stability is expected to be better, but total efficiency is less.

In order to keep the k-vector of the light in the second pass in the same direction as it was in the first pass, one cannot use a simple linear cavity.

Only when using a ring-cavity containing a unidirectional element will the wave vector of the light that has not been refracted by the holographic storage medium remain the same. Each next pass-through the holographic storage medium will contribute to data readout.

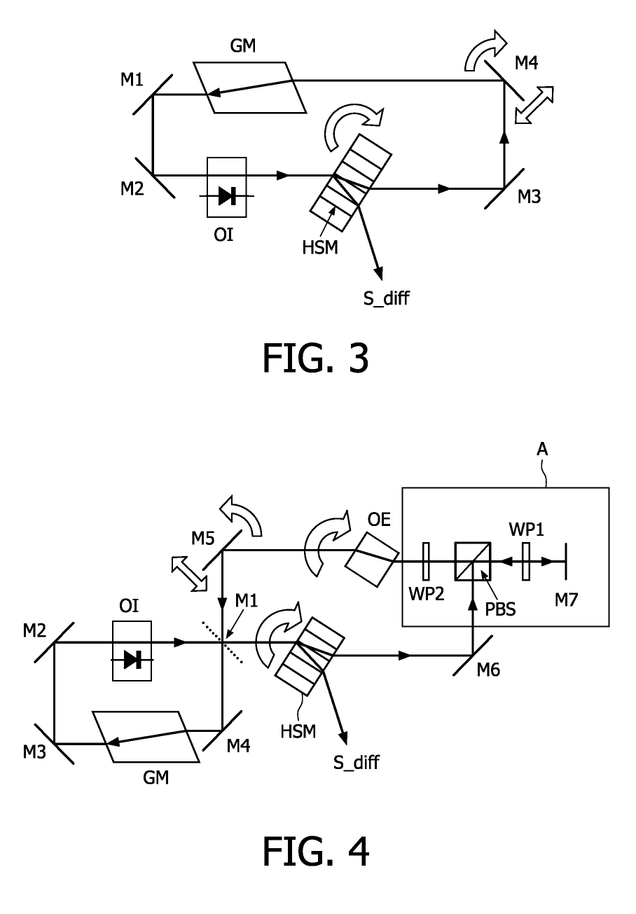

FIG. 3 represents a first optical cavity according to the invention for reading a holographic storage medium HSM.

The optical cavity is composed of various elements connected such that a closed optical path is defined. The optical cavity may also be referred to as ring cavity because of the shape of the optical path along which the same photons do not propagate in both forward and backward directions (i.e. non-overlapping path sections).

The cavity comprises a gain medium GM for generating along said optical path a laser beam intended to pass through the holographic storage medium HSM placed along the closed optical path, in view of reading the holographic data stored in the holographic storage medium. The gain medium GM determines the wavelength and other characteristics of the laser beam generated. The gain medium GM is excited by a pump source in charge of providing energy (not shown) to produce a population inversion, and it is in the gain medium that spontaneous and stimulated emission of photons takes place, leading to the phenomenon of light amplification, also called optical gain. For example, the gain medium may be of the liquid, gas, solid or semiconductor type.

The optical cavity comprises a set of mirrors (M1, M2, M3, M4) positioned along the optical path so as to close the optical path. Advantageously, at least one of these mirrors (e.g. M4) is movable in rotation and/or in translation so that the optical path is controlled in view of an easier lasing adjustment.

The readout of the holographic storage medium HSM is for example done in varying its relative angle compared to the optical path, as illustrated by the turning arrow.

Optionally and advantageously, the optical cavity may comprise an optical isolator OI. The optical isolator is a unidirectional device, an elementary optical element usually based on the Faraday effect (a magneto-optical effect). Usually, the optical isolator is polarization sensitive and may contain a magnet around a transparent material with a high Verdet constant and a linear polarizer. The purpose of the optical isolator is to prevent the photons to travel in “the undesired direction”. Indeed, since a photon has a well-defined so-called wave vector k, a photon travelling in the opposite direction has the opposite wave vector (i.e. −k). Such a photon travelling in the undesired direction would therefore result in phase-conjugate read out the hologram, resulting in reconstructing a wave front not arriving at the detector and thus leading to undesired light loss. In the present case, only one diffracted beam S_diff is generated.

FIG. 4 represents a second optical cavity according to the invention for reading a holographic storage medium HSM.

The optical cavity is composed of various elements connected such that a closed optical path is defined. The optical cavity may also be referred to as ring cavity because of the shape of the closed optical path along which the same photons do not propagate in both forward and backward directions (i.e. non-overlapping path sections).

Depending on the specific laser power and laser mode that is used in reading out the holographic storage medium, it may be better not to have a single cavity (as described in FIG. 3) comprising not only elements used to generate the laser but also elements used for reading out hologram data. Indeed, since the holographic storage medium is intended to be placed along the optical path and rotated in view of reading out hologram data, it might affect stability of lasing phenomenon.

The closed optical path thus comprises a first loop also referred to as “laser gain cavity”, and a second loop also be referred to as “readout cavity”, the first loop and the second loop being coupled with a coupling mirror M1.

The purpose of the coupling mirror M1 is to decouple (at least partially) the first loop from the second loop. The coupling mirror may have a transmission between a few percent up to (but less than) 100%. The higher the reflection of the coupling mirror, the more stable the gain cavity, because it is more isolated from the external world, and in particular from the second loop used to readout the holographic storage medium. The drawback of a highly reflecting coupling mirror is that the light intensity in the second may be reduced, depending on the optical losses in that part of the cavity.

This results in a more stable lasing phenomenon, while continuously feeding new photons into the second loop so as to replace photons lost by diffraction or other optical losses.

The first loop comprises:
a gain medium GM: this element determines the wavelength and other characteristics of the laser beam generated. The gain medium is excited by a pump source in charge of providing energy (not shown) to produce a population inversion, and it is in the gain medium that spontaneous and stimulated emission of photons takes place, leading to the phenomenon of optical gain, amplification. For example, the gain medium may be of the liquid, gas, solid or semiconductor type.
a set of mirrors (M2, M3, M4) for closing the optical path of said first loop, together with the coupling mirror M1.

Optionally, the first loop comprises an optical isolator OI inserted along the optical path of said first loop. The optical isolator is a unidirectional device, an elementary optical element usually based on the Faraday effect (a magneto-optical effect). Usually, the optical isolator is polarization-sensitive and may contain a magnet around a transparent material with a high Verdet constant and a linear polarizer. The purpose of the optical isolator is to prevent the photons to travel in “the undesired direction”: since a photon has a well-defined wave vector k, a photon travelling in the opposite direction has the opposite wave vector (i.e. −k). Such a photon travelling in the undesired direction would therefore result in phase-conjugate read out the hologram, resulting in reconstructing a wave front not arriving at the detector and thus leading to undesired light loss.

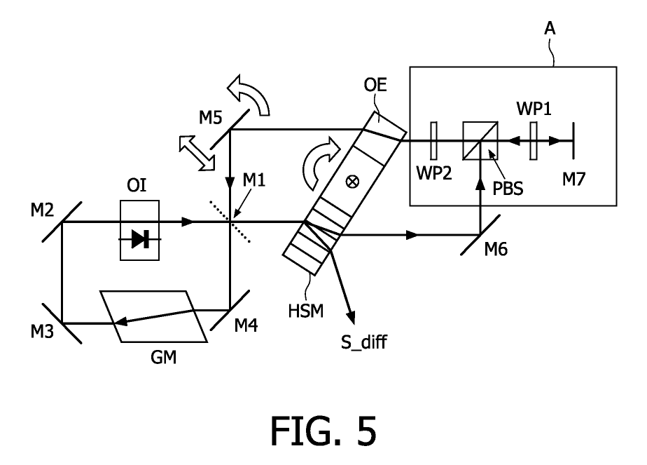

The second loop comprises:
An arrangement A (which may be referred to as a beam displacement compensator) for changing the sign of the wave vector along the optical path: this arrangement comprises a polarizing beam splitter PBS, a quarter wave plate WP1, a mirror M7 and a half wave plate WP2. The light first passes through the polarizing beam-splitter. Such a beam-splitter reflects light with one linear polarization, while transmitting light with the other linear polarization. The quarter wave WP2 plate has the property that it changes the linear polarization of the light in the cavity to circularly polarized light, and back. Subsequently, the light is reflected by the mirror M7, and changes handedness upon reflection. The polarization is changed to linear again by the second pass through the quarter wave plate WP1, but now with orthogonal orientation to the original polarization inside the cavity, and hence transmitted by the polarizing beam splitter PBS to the half wave plate WP2. The half wave plate is used to rotate the linear polarization of the beam again. After passing through the half wave plate, the beam has finally returned to the original linear polarization. The purpose of the arrangement A is to maintain the optical path length of the cavity, i.e. the lateral displacement between the incoming and outgoing beams of this arrangement, irrespective of rotation of the holographic medium and the compensation plate. Note that this could also be achieved, for example, by a suitable arrangement (not shown) comprising two mirrors of the so-called penta-prism type (i.e. having the shape of a kite).
An optical element OE for compensating for the changes of the optical path length caused by a displacement of said holographic storage medium: this optical element is put inside the return path to compensate for lateral displacements of the light beam. This embodiment comprises actuation means (not shown) for rotating said optical element OE so as to follow an angular displacement of said holographic storage medium. Advantageously, the optical element may be part of the hologram, as illustrated in FIG. 5. Advantageously, this optical element OE has the same thickness and same refractive index as that of the hologram intended to be inserted in the light path of said second loop for readout.
A set of mirrors (M5, M6) for closing the optical path of said second loop, together with the coupling mirror M1 and the arrangement A. Advantageously, one of these mirrors (e.g. M5) maybe movable in translation and/or rotation so that the path length is adjusted to keep the cavity on resonance.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. Any reference signs in the claims should not be construed as limiting the scope.

1. A system for reading a holographic storage medium (HSM), said system comprising an optical ring cavity defining a closed optical path.

2. A system as claimed in claim 1, wherein said optical ring cavity further comprises a gain medium (GM) for generating along said closed optical path a laser beam intended to pass through said holographic storage medium (HSM).

3. A system as claimed in claim 1 wherein said optical ring cavity further comprises an optical isolator (OI) positioned along said closed optical path.

4. A system as claimed in claim 1 wherein said closed optical path comprises a first loop and a second loop coupled with a coupling mirror (M1), said first loop comprising said gain medium (GM), said second loop comprising an arrangement (A) for changing the sign of the wave vector along the closed optical path, and an optical element (OE) for compensating for the changes of the closed optical path length caused by a displacement of said holographic storage medium (HSM).

5. A system as claimed in claim 4, further comprising actuation means for rotating said optical element (OE) so as to follow an angular displacement of said holographic storage medium (HSM).

6. A system as claimed in claim 4, wherein said optical element has a thickness and a refractive index identical to that of said holographic storage medium (HSM).

7. A system as claimed in claim 4, wherein said optical element (OE) is part of said holographic storage medium.

8. A system as claimed in claim 4, wherein said optical ring cavity further comprises an optical isolator (OI) positioned along said closed optical path.
